(19) United States
(12) Patent Application Publication
(10) Pub. No.: US 2014/0190465 A1
(43) Pub. Date: Jul. 10, 2014

(54) SYSTEM AND METHOD FOR DIVIDING SILICON BLOCKS

(71) Applicant: DEUTSCHE SOLAR GMBH, Freiberg (DE)

(72) Inventors: Bianca BÜRKNER, Meerane (DE); Nathan STODDARD, Beaverton, OR (US); Tobias VOGEL, Hartenstein (DE)

(73) Assignee: DEUTSCHE SOLAR GMBH, Freiberg (DE)

(21) Appl. No.: 14/139,448

(22) Filed: Dec. 23, 2013

(30) Foreign Application Priority Data
Jan. 4, 2013 (DE) 102013200079

(51) Int. Cl. B28D 5/04

(52) U.S. Cl. CPC B28D 5/045
USPC 125/21

(57) ABSTRACT

The invention relates to a method for dividing silicon blocks, including the following steps: providing a cuboidal silicon block, dividing the silicon block into at least two bars in a first dividing step, turning the bars in a turning step by 90° respectively around a rotational axis perpendicular to the longitudinal direction of the block and dividing the bars into silicon ingots in a second dividing step.

The invention relates to a system and a method for dividing silicon blocks. The invention furthermore relates to a method for producing silicon ingots.

For producing semiconductor components, particularly solar cells, normally large-volume silicon blocks are initially produced, which are subsequently divided into bars, ingots and wafers successively. Such a method is known from the document DE 10 2010 029 741 A1.

The object of the invention is to improve a system and a method for dividing silicon blocks.

The basis of the invention is in dividing a silicon block initially into bars, to rotate these and thereafter to divide the bars into ingots.

For dividing the silicon blocks, these are arranged on a retaining device, particularly in the form of a trolley. Then, they are divided by means of a briquetting machine. In accordance with the invention, the briquetting machine is configured such that it includes a single wire web, which has in particular, three parallel cutting sections.

According to one aspect of the invention, the briquetting machine is suitable for this purpose, for dividing the silicon block in the middle. It is particularly suitable for dividing the silicon block through a section along a middle longitudinal plane. Here, the longitudinal direction corresponds to the growth direction of the silicon block. Preferably, the briquetting machine is additionally suitable for severing two side slabs from the silicon block.

According to one aspect of the invention, the cuboidal silicon block to be divided has a <110> orientation extending parallel to the longitudinal direction of the block. In particular, it has a rectangular, square cross-sectional area in the direction perpendicular to the longitudinal direction. In particular, it has a crystal structure such that a first side of the cross-sectional area extends parallel to a <110> orientation and a second side of the cross-sectional area extends parallel to a <100> orientation.

The side lengths of the cross-sectional areas are, in particular, approximately twice the height of the block, i.e. twice the height of its extension in the longitudinal direction. The block can particularly have the following dimensions: 830 mm×830 mm×410 mm.

According to one aspect of the invention, in a first dividing step, the block is divided into at least two bars, particularly in exactly two bars. For this purpose, the block is particularly divided along at least a cutting plane extending parallel to the longitudinal direction.

In addition, in the first dividing step, two parallel side slabs can be separated from the silicon block. The side slabs have a thickness in the range of 1 cm to 3 cm.

In the first dividing step, the block is preferably divided along several, particularly three sectional planes extending parallel to the longitudinal direction. Here, a section plane preferably extends along a middle longitudinal plane of the block. It may also be advantageous to divide the block into two unequal bars. In this case, the middle section plane extends parallel offset with respect to the middle plane of the silicon block.

For carrying out the first dividing step, i.e. for dividing the silicon block, a briquetting machine with a single wire web having three parallel cutting sections is provided. The wire web particularly has exactly three cutting sections.

According to another aspect of the invention, the bars, into which the silicon block is divided in the first dividing step, have identical dimensions. The deviations in the correlating dimensions are, particularly less than 10%. According to an alternative embodiment, in the first step, the block is divided into bars of different sizes. This may be advantageous in order to produce ingots with certain preferred lengths.

According to another aspect of the invention, the bars respectively have an approximately square cross-section.

The bars can particularly have the following dimensions: 390 mm×830 mm×410 mm.

The bars have particularly a crystal structure with a <110> orientation along their longitudinal direction. The bars preferably have <110>- and <100>-orientation perpendicular to the longitudinal direction.

According to another aspect of the invention, the rotational axis, around which the bars are rotated, extends respectively parallel to its longitudinal axis, i.e. parallel to its <110> orientation. While in the initial state, the silicon block has a <110> orientation in the longitudinal direction, i.e. in the vertical direction, which necessarily corresponds with the orientation of the crystal structure of the bars in the vertical direction before the rotation of the bars; after the rotation in the vertical direction, the bars have a crystal orientation which is parallel or antiparallel to a <100> direction. The bars are particularly rotated at 90° around the rotational axis. They can be rotated towards right or towards left, i.e. in the clockwise direction or in the anticlockwise direction.

According to another aspect of the invention, in the rotational step, the bars are particularly rotated such that in the first dividing step, they come in contact with sawed side of the slab. Alternatively, it is possible for this purpose, to rotate the bars in the rotational step such that they come in contact with the sides, which were previously in the middle of the block.

According to another aspect of the invention, in the second dividing step, slabs are separated from the bars. In particular, respectively two slabs are separated in the longitudinal direction and/or in the transverse direction, from each of the bar.

According to another aspect of the invention, in the second dividing step, the bars are divided along a cutting plane extending parallel to a longitudinal axis of the bars and along a cutting plane extending perpendicular to the longitudinal axis of the bars. The cutting planes particularly extend parallel to the vertical direction. In the method in accordance with the invention, consequently the silicon block is divided exclusively through the section parallel to the vertical direction.

The bars are particularly divided into silicon ingots such that the silicon ingots have a longitudinal direction extending parallel to a <100> orientation. The silicon ingots particularly have a square cross-section. The cross-section of the silicon ingots preferably corresponds exactly to the cross-section of the wafer to be produced from these ingots. It can particularly measure 156 mm×156 mm. It may also measure 208 mm×208 mm, 260 mm×260 mm, 312 mm×312 mm or other values. Smaller cross-sections are also possible.

According to another aspect of the invention, for the second dividing step, a briquetting machine is provided with two wire webs each having at least four, particularly having six parallel cutting sections. The wire webs are particularly transverse to each other; in particular they have cutting sections which are arranged perpendicular to each other. Alternatively for this purpose, it may be advantageous to configure one or both of the wire webs with seven parallel cutting sections. The number of the parallel cutting sections in the wire webs provided for the second dividing step can be flexibly selected from the size of the blocks to be divided and from the size of the ingots to be produced. It is also possible to configure both the wire webs with a different number of parallel cutting sections for the second dividing step. In particular, it may be provided to configure a wire web with an even number of parallel cutting sections and the other wire web with an uneven number of parallel cutting sections.

According to another aspect of the method, the silicon ingots produced from the silicon block have an extension in a longitudinal direction of the ingot, which substantially corresponds to the extension of the silicon block in the longitudinal direction of the block, i.e. in the direction of growth. The ingot length particularly deviates maximum by 25%, particularly maximum by 10%, particularly maximum by 5% from the extension of the silicon block in the direction of growth.

Another object of the invention is to improve the method for producing silicon ingots with longitudinal axis parallel to a <100> direction.

This object is achieved by the features of the claim 11. The advantages follow from the previous description.

A method of crystallization is provided for producing the silicon block. In particular, the silicon block can be produced by means of a Bridgman method or a Vertical-Gradient-Freeze method (VGF-method). In particular, lumpy silicon can be fused and solidified, particularly directionally solidified for producing the silicon block.

In particular, the silicon block has a monocrystalline structure at least up to 50% by volume, particularly at least 70% by volume. One such structure is also referred to as quasi-monocrystalline structure. The method can also be advantageously applied on multi-crystalline silicon blocks. It may be particularly advantageous for dividing multi-crystalline silicon blocks, which have a varying characteristic over its height, particularly a varying dopant concentration and/or distribution over the block height.

Further features and details of the invention follow from the description of an exemplary embodiment with the help of drawings. They show:

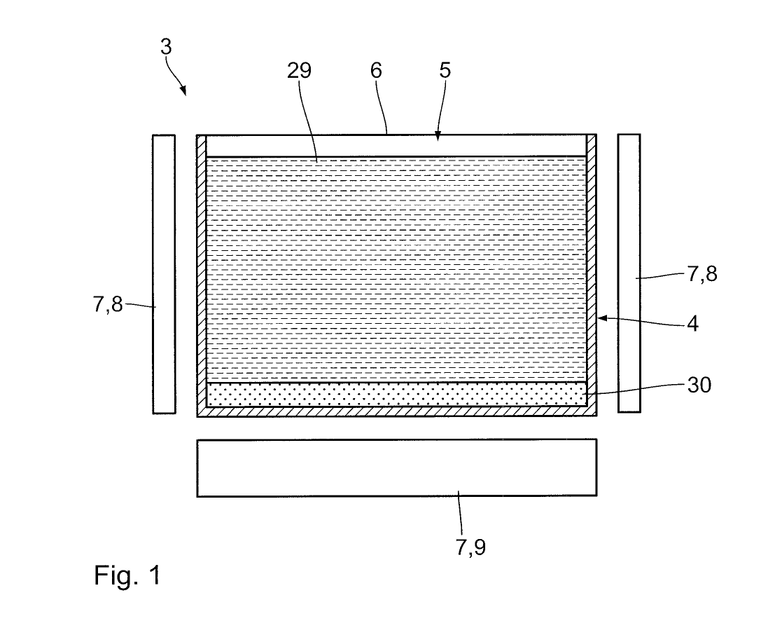

FIG. 1 shows a schematic representation of a device for producing silicon blocks,

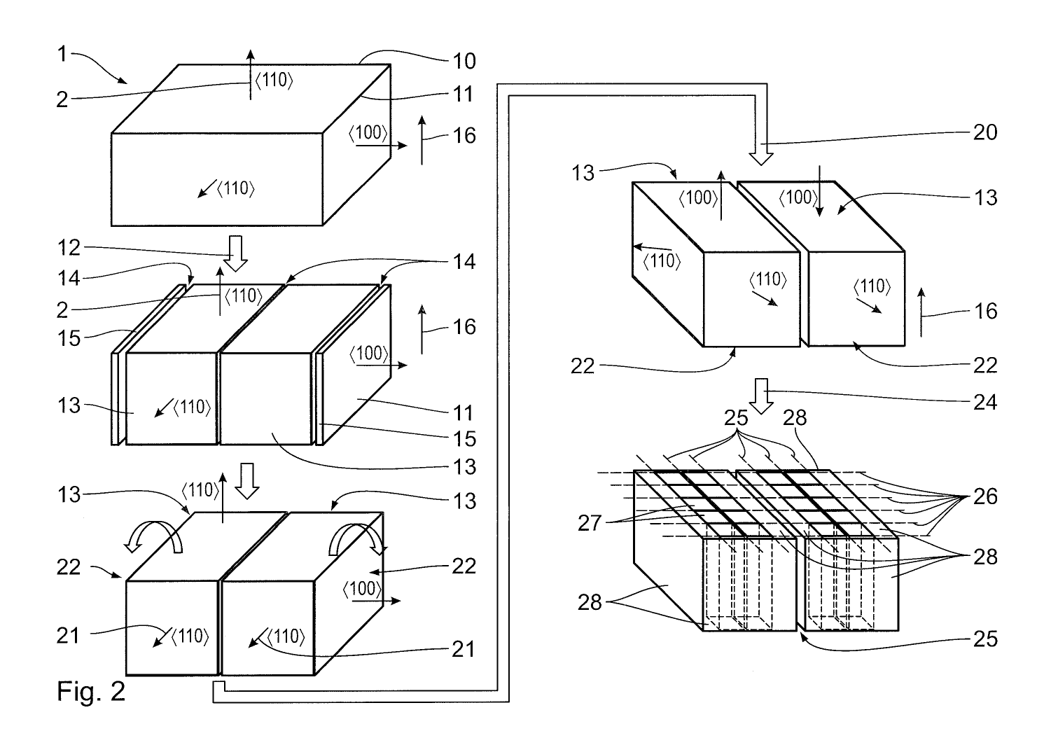

FIG. 2 shows a schematic representation of the method for dividing silicon blocks,

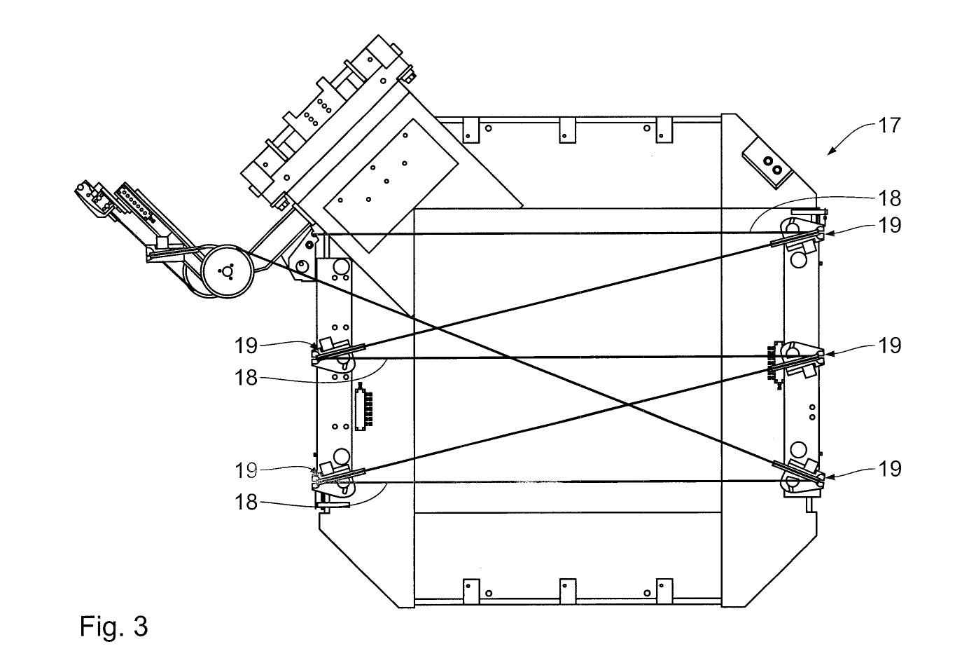

FIG. 3 shows a schematic view from above, of the briquetting machine provided for the first dividing step, and

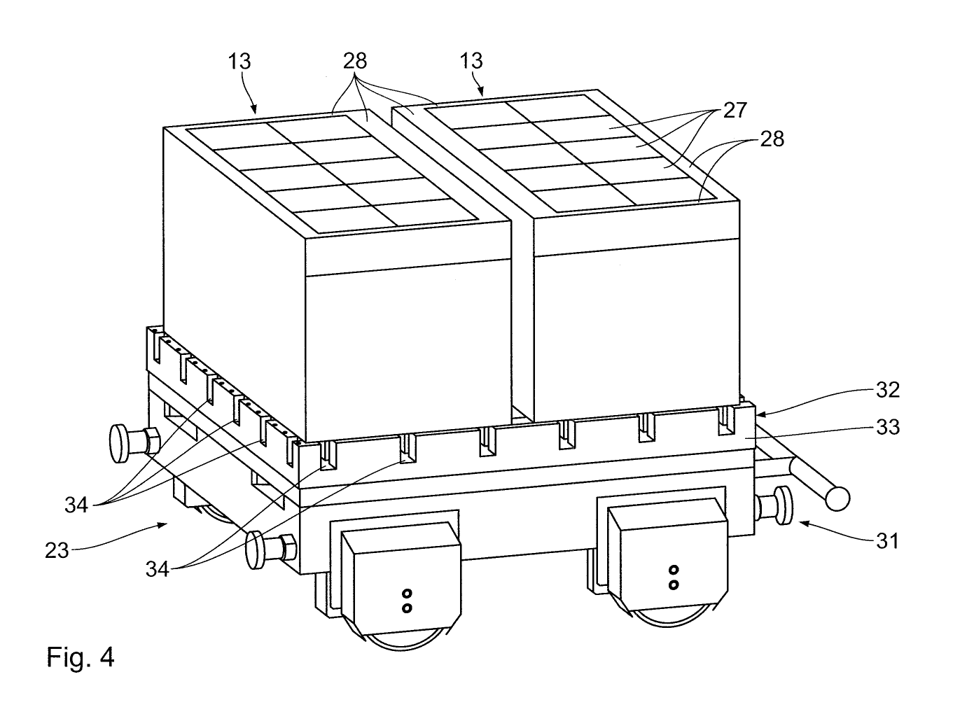

FIG. 4 shows a schematic view of a trolley with two bars before carrying out the second dividing step.

In the method in accordance with the invention, initially a cuboidal silicon block 1 is provided. The silicon block 1 has a <110> crystal orientation extending parallel to a longitudinal direction 2 of the block.

A method of crystallization is provided for producing the silicon blocks 1. The silicon block 1 can particularly be produced according to a Bridgman method or a Vertical-Gradient-Freeze method (VGF method). For this purpose, the system in accordance with the invention includes a device 3 schematically represented in FIG. 1, for fusing and crystallizing silicon. The device 3 includes a crucible 4 for accommodating a silicon melt 29. The crucible 4 particularly has the shape of a cuboid open at the top. It can particularly have a square cross-section. The crucible 4 confines an inner chamber 5 open on one side. The inner chamber 5 can be filled through an opening 6. One or more seed defaults 30 can be arranged at the bottom of the crucible 4.

In addition, the device 3 includes a temperature control device 7. The temperature control device 7 in turn includes several heating elements 8. It may also include cooling elements 9. With the help of the temperature control device 7, it is possible to selectively heat and cool the inner chamber 5 of the crucible 4.

For further details of the device 3 for producing the silicon block 1 and about the method of producing the same, reference may be made to the document DE 10 2010 029 741 A1, which is hereby completely incorporated in this as a part of the present application.

The method according to the document U.S. Ser. No. 13/561,350 can also be provided for producing the silicon block 1, which is also hereby completely incorporated in this as a part of the present application.

The silicon block 1 has a monocrystalline structure, at least up to 50% by volume, particularly at least 70% by volume, particularly at least 90% by volume. Therefore, it is also referred to as a quasi monocrystalline silicon block 1.

The silicon block 1 has square cross-sectional area with a first side 10 and a second side 11. The first side 10 extends perpendicular to a <110> orientation. The second side 11 extends perpendicular to a <100> orientation. The crystal orientations are respectively indicated by arrows in FIG. 2.

The silicon block 1 has an extension of 410 mm in longitudinal direction 2 of the block. It has cross-sectional area of 830 mm×830 mm. However, other dimensions are also possible. In principle, the blocks of any size can be used. If applicable, they can be divided into silicon blocks 1 of suitable sizes before further processing, where necessary. In addition, it is possible to use silicon block 1 with a non-square cross-sectional area. The silicon block 1 can particularly have a cross-sectional area, the side lengths of which is in a random whole-numbered ratio, particularly in the ratio of 1:2, 1:3, 1:4, 2:3, 3:4. An application of the following described method for dividing such blocks is possible in a simple manner.

In a first dividing step 12, the silicon block 1 is divided. The silicon block 1 is particularly divided into two bars 13. In principle, it can also be divided into more than two bars 13.

For dividing silicon block 1, this is arranged on a trolley 23. The trolley 23 forms a holding device for holding the silicon block 1 to be divided. The holding device is a component of the system. The trolley 23 particularly includes a transporting element, particularly in the form of a transport trolley 31 and a holding element arranged thereon, particularly in the form of a holding plate 32 placed on the transport trolley 31. The holding plate 32 includes a surrounding edge 33. Recesses 34 are introduced in the edge 33. The recesses 34 are slotted. They are arranged at the positions, at which the cutting planes pass. The holding plate 32 can particularly be arranged replaceable on the transport trolley 31. Because of this, it is possible for the trolley 23, particularly the holding plate 32 specifically in the dividing step 12, particularly to match the course of the cutting section provided here.

For dividing the silicon block 1, this is divided in the first dividing step along three cutting planes 14 extending parallel to the longitudinal direction 2 of the block. The block is particularly divided at least along a cutting plane extending parallel to the longitudinal direction 2 of the block. Here, one of the cutting planes 14 passes along a middle longitudinal plane of the silicon block 1. The other two cutting planes 14 extend parallel to this middle longitudinal plane. They are used for removing two side slabs 15 in the first dividing step 12. The side slabs 15 are oriented parallel to each other. They are separated from the opposite sides of the silicon blocks 1. They are part of the marginal surrounding region of the silicon block 1. The crystal structure of the silicon block 1 can have defects in this marginal region. The side slabs 15 have a thickness in the range of 1 cm to 3 cm. The side slabs 15 are removed after their separation from the silicon block 1.

The cutting planes 14 extend particularly parallel to a vertical direction 16. Therefore, the sections are referred to as vertical sections.

For dividing the silicon block 1 in the first dividing step 12, the system includes a briquetting machine 17, which has a single wire web with exactly three parallel cutting sections 18. A wire saw for rough division of silicon blocks 1 is referred to as a briquetting machine. A schematic representation of the briquetting machine 17 is shown in FIG. 3. The briquetting machine 17 was obtained by suitable modification of the sawing device known from the document DE 10 2011 004 341 A1. For producing the briquetting machine 17, in particular, the number and arrangement of deflection rollers 19 and wire guiding rollers which are not visible in FIG. 3, was suitable adapted. Moreover, a reference shall be made to the document DE 10 2011 004 341 A1 for the basic details of the construction of the briquetting machine 17, which shall hereby be completely incorporated in this as a part of the present application.

The middle cutting section 18 is used for dividing the silicon block 1 along its middle longitudinal plane. Both the outer cutting sections 18 are used for separating the side slabs 15 from the silicon block 1.

In principle, a briquetting machine with an alternative wire web is also possible for carrying out the first dividing step 12. However, a briquetting machine with a single wire web with exactly three parallel cutting sections 18 is apparently particularly advantageous.

The bars 13 have identical dimensions. The dimensions of the bars 13 measure, for instance 390 mm×830 mm×410 mm. Their longitudinal direction extends parallel to the <110> orientation. They have an approximately square cross-section. The side lengths of the transverse section of the bars 13 differ, particularly by about less than 10%. The bars 13 can also have a rectangular cross-section, wherein the side lengths differ from each other by more than 10%, particularly by more than 30%, particularly by more than 50%.

In a turning step 20, the bars 13 are respectively rotated by 90° around a respective rotational axis 21 extending perpendicular to the longitudinal direction 2 of the block. The rotational axis 21 extends respectively parallel to a <110> orientation of the bars 13. The bars 13 are turned such that they come on the slab side 22 sawed in the first dividing step 12. Here, the side surfaces of the bars 13 protruding through the middle cutting plane 14 are turned such that they form an upper side of the bars 13. After the turning, which is also referred to as tipping, the bars 13 have a <100> orientation, which extends parallel or antiparallel to the vertical direction 16.

The turned bars 13 are in turn arranged on a trolley 23. It may be the same trolley 23, which is used for holding the silicon block 1 in the first dividing step 12. In principle, the same holding plate 32 as used in the first dividing step 12 can also be used. According to the arrangement of the wire web, in the following, another holding plate 32, particularly having another arrangement of recesses 34 can also be used. It is also possible to use several trolleys 23.

In a second dividing step 24, the bars can be divided along the first cutting plane 25 extending parallel to the longitudinal axis of the bars and along the second cutting planes 26 extending perpendicular to the longitudinal axis of the bars. All the cutting planes 25, 26 extend parallel to the vertical direction 16. In the method for dividing silicon block 1 into silicon ingots 27, thus exclusively vertical sections, i.e. sections along the vertical cutting planes are provided.

For the second dividing step 24, respectively six first cutting planes 25 and six second cutting planes 26 are provided. These are generated by a briquetting machine with two wire webs with respectively six parallel cutting sections. Both the wire webs of the briquetting machine provided for the second dividing step 24 are transverse to each other; they extend particularly perpendicular to each other. For the second dividing step, likewise, a wire saw, suitably modified with respect to the one which is known from the document DE 10 2011 004 341, can be used. The briquetting machine provided for the second dividing step 24 particularly differs from the briquetting machine provided for the first dividing step 12, merely by the arrangement of the wire web. The arrangement of the wire web is specified here by the arrangement of the deflection rollers 19 and the wire guiding rollers.

In the second dividing step 24, the bars 13 are respectively divided into a plurality of silicon ingots 27. In addition, in the second dividing step 24, side slabs 28 are separated from the bars 13. In particular, two side slabs 28 opposite to each other in the longitudinal direction of the bar are separated from each bar 13, In particular, two side slabs 28 opposite to each other in the direction perpendicular to the longitudinal direction of the bar are separated from each bar 13.

The combination of the side slabs 15 separated from the silicon block 1 in the first dividing step 12 and the side slabs 28 separated from the bars 13 in the second dividing step 24 includes the overall surface of the silicon block 1. Therefore, the silicon ingots 27 fully and completely originate from a core region, i.e. from a region spaced apart from the surface of the same silicon block 1. Therefore, they are particularly from a defect-free region of the silicon block 1.

In the second dividing step 24, silicon ingots 27 are separated from each of the bars 13. In particular, two parallel rows of each five silicon ingots 27 are separated from each bar 13. Therefore, the total number of the silicon ingots 27 separated from the silicon block 1 is 20. The silicon ingots 27 have a length which corresponds to, except for the thickness of the side slabs 15 and taking into account of the loss of almost half of the first side 10 of the cross-sectional area of the silicon block 1 during the cutting. The length of the silicon ingots 27 particularly substantially corresponds to the extension of the silicon block 1 in the longitudinal direction 2 of the block. The length of the silicon ingots 27 deviates, particularly maximum by 25%, particularly maximum by 10%, particularly maximum by 5% from the extension of the silicon block 1 in the longitudinal direction 2 of the block.

The division of the silicon block 1 into silicon ingots 27 thus includes exactly two dividing steps 12, 24 independent from each other. The <110> oriented silicon block 1 is divided into <100> oriented silicon ingots 27 by the dividing steps 12, 24. Between the first dividing step 12 and the second dividing step 24, the bars 13 separated from the silicon block 1 in the first dividing step 12 are turned around their longitudinal axes. For both the dividing steps 12, 24, the silicon block 1 or the bars 13 are respectively placed on the trolley 23 and fixed to this. For the second dividing step 24, an additional slab holder can be provided for fixing both the bars 13. The additional slab holder is preferably arranged on the holding plate 32. In particular, it is arranged in the region between the two bars 13. It is also possible to arrange several additional slab holders on the holding plate 32.

With the help of the trolley 23, the silicon block 1 or the bars 13 can respectively be pushed into the briquetting machine 17 provided for the first dividing step 12 or for the second dividing step 24.

1. System for dividing silicon blocks comprising:
a. a holding device for holding a silicon block to be divided,
b. a first briquetting machine with a wire web, and
c. a second briquetting machine with two partial wire webs, which respectively have several parallel cutting sections, wherein the cutting sections of the partial wire webs extend respectively perpendicular to each other.

2. Method for dividing silicon blocks comprising the following steps:
a. providing a cuboidal silicon block,
b. in a first dividing step, dividing the silicon block into at least two bars,
c. turning the bars in a turning step by 90° respectively around a rotational axis extending perpendicular to the longitudinal direction of the block,
d. in a second dividing step, dividing the bars into silicon ingots.

3. Method according to claim 2, wherein, in the first dividing step, the silicon block is divided along several cutting planes extending parallel to the longitudinal direction of the block.

4. Method according to claim 3, wherein, a cutting plane passes along a middle plane of the silicon block.

5. Method according to claim 2, wherein, in the first dividing step, two side slabs are separated from the silicon block.

6. Method according to claim 2, wherein, the rotational axis extends respectively parallel to a <110> orientation of the bars.

7. Method according to claim 2, wherein, in the second dividing step, slabs are separated from the bars.

8. Method according to claim 2, wherein, in the second cutting step, the bars are divided along a cutting plane extending parallel to a longitudinal axis of the bars and along a cutting plane extending perpendicular to the longitudinal axis of the bars.

9. Method according to claim 2, wherein, for the second dividing step, a briquetting machine with two wire webs is provided respectively having at least four parallel cutting sections.

10. Method according to claim 2, wherein, exclusively vertical cutting planes are provided.

11. Method for producing silicon ingots with longitudinal axes parallel to a <100> direction comprising the following steps:
a. producing a silicon block with a longitudinal direction of the block parallel to a <110> direction,
b. dividing the silicon block according to claim 2.
